(19) United States
(12) Patent Application Publication
(10) Pub. No.: US 2005/0184420 A1
(43) Pub. Date: Aug. 25, 2005

(54) Foaming die and method of foaming components

(75) Inventors: Christian Biewer, Munster-Altheim (DE); Horst Schonebeck, Gelnhausen (DE)

Correspondence Address: CARLSON, GASKEY & OLDS, P.C., 400 WEST MAPLE ROAD, SUITE 350, BIRMINGHAM, MI, 48009, US

(73) Assignee: ArvinMeritor GmbH

(21) Appl. No.: 11/029,883

(22) Filed: Jan. 5, 2005

(30) Foreign Application Priority Data
Feb. 20, 2004 (DE) 10 2004 008 412.2

(51) Int. Cl. B29C 44/00

(52) U.S. Cl. 264/51; 425/4 R; 425/387.1

(57) ABSTRACT

A foaming die comprises a lower part and an upper part. A foaming cavity is formed between the lower part and the upper part, and a membrane is mounted on the inside of the foaming die at the inside of at least one of the lower part and the upper part. The membrane delimits the foaming cavity and transports gas to gas outlet openings during the foaming process. The invention is particularly suitable for forming vehicle body panel parts with a foamed backing.

### REFERENCE TO RELATED APPLICATIONS

The present invention claims the benefit of German Patent Application No. 10 2004 008 412.2, filed Feb. 20, 2004.

### TECHNICAL FIELD

The present invention relates to a foaming die comprising a lower part, an upper part, and a foaming cavity formed therebetween. The invention further relates to a method of foaming components, particularly of providing a vehicle body panel part with a foam backing.

### BACKGROUND OF THE INVENTION

Vehicle body panel parts are parts that define at least portions of the outer skin of the vehicle when the vehicle is finally assembled. In particular, the invention relates to a method of manufacturing a vehicle roof module, i.e., a large-surface composite structure that is attached on the roof frame and that forms the major part of the roof skin.

High demands are made on the surface quality of the outer skin, especially in manufacturing body panel parts having a foamed backing. In this method, sheets that will later define the outer skin are usually provided with a foamed backing of polyurethane material. The chemical reaction process used to foam the polyurethane material produces a large outgassing volume. This gas volume should be able to escape from the foaming die in order to obtain good foaming results. If the escape path of the gas allows the gas to escape only partially or prevents the gas from escaping at all, air will be trapped in the foamed backing and produce surface defects on the outer skin.

There is a desire for a foaming die as well as a method of manufacturing foamed components (e.g., a vehicle body panel part with a foamed backing) method that can produce foamed components with better quality.

### SUMMARY OF THE INVENTION

A foaming die according to one embodiment of the invention includes at least one membrane extending across an area to delimit a foaming cavity that is mounted on the inside of the lower and/or upper part. The outside of the membrane is adjacent to a pressure chamber.

The membrane is an integral element of the foaming die and is able to deform elastically so that the volume of the foaming cavity is variable due to the pressure chamber lying behind it. The membrane is able to yield to the foaming pressure resulting from degassing. The additional volume formed by the yielding of the membrane is used for degassing. The gas will therefore not later drift to the outer surface of the foamed component at the portion of the foaming die that is not provided with the membrane.

During this inventive process of providing sheets, in particular deep-drawn plastic or aluminum sheets for roof modules, with a foamed backing, fewer or no irregularities or sink marks are produced on the side of the sheet because the invention allows gas to be released more easily.

The inventive method of foaming components, and particularly a method of providing a vehicle body panel part with a foamed backing, uses the above-discussed foaming die according to the invention. To provide a foamed backing according to one embodiment of the invention, a sheet on which the foamed backing is to be applied is placed in the foaming die. Next, a liquid plastic material, such as liquid polyurethane, is applied onto the sheet. The die is closed to place the liquid plastic material in contact with the membrane. Thus, the sheet itself does not rest on the membrane.

As explained above, the pressure is applied to the membrane on its outside surface during the outgassing of the liquid plastic material to guide the direction of the escaping gas.

### BRIEF DESCRIPTION OF THE DRAWINGS

Further features and advantages of the invention will become apparent from the description given below and from the accompanying drawings to which reference is made and in which:

FIG. 1 is a perspective top view of a vehicle roof module manufactured by a foaming die according to one embodiment of the invention and one embodiment of the inventive method,

FIG. 2 is a schematic sectional view of the foaming die according to the invention in the open condition,

FIG. 3 shows the foaming die of FIG. 2 immediately after closing, and

FIG. 4 shows the foaming die of FIG. 2 during a pressure increase in the pressure chamber.

### DETAILED DESCRIPTION OF THE EMBODIMENTS

The invention is generally directed to a foaming die and a foaming method for applying a foamed backing to a sheet to form a foamed component. A foaming die according to one embodiment of the invention includes at least one membrane extending across an area to delimit a foaming cavity that is mounted on the inside of the lower part and/or the upper part. The outside of the membrane is adjacent to a pressure chamber.

The membrane is an integral element of the foaming die and is able to deform elastically so that the volume of the foaming cavity is variable due to the pressure chamber lying behind it. The membrane is able to yield to the foaming pressure resulting from degassing. The additional volume formed by the yielding of the membrane is used for degassing. The gas will therefore not later drift to the outer surface of the foamed component generated at the portion of the foaming die that is not provided with the membrane.

During this inventive process of providing sheets, in particular deep-drawn plastic or aluminum sheets for roof modules, with a foamed backing, fewer or no irregularities or sink marks are produced on the side of the sheet because the invention allows gas to be released more easily.

Pressure may be selectively applied to the outer chamber to produce a controllable counter pressure in a purposeful way. To this end, a pump may be coupled to the pressure chamber.

Gas outlet openings may be provided in the foaming die between the lower and the upper part. The pump allows the membrane to apply a different counter pressure during the outgassing of the incorporated plastic material. By changing the pressure in a controlled manner (e.g., periodically), the membrane itself can act as a pump to transport the gas contained in the foaming cavity to the gas outlet openings.

The inventive method of foaming components, and particularly of providing a vehicle body panel part with a foamed backing, uses the above-discussed foaming die according to the invention.

To provide a foamed backing according to one embodiment of the invention, a sheet on which the foamed backing is to be applied is placed in the foaming die. Next, a liquid plastic material, such as liquid polyurethane, is applied onto the sheet. The die is closed to place the liquid plastic material in contact with the membrane. Thus, the sheet itself does not rest on the membrane.

As explained above, the pressure is applied to the membrane on its outside surface during the outgassing of the liquid plastic material to guide the path of the escaping gas.

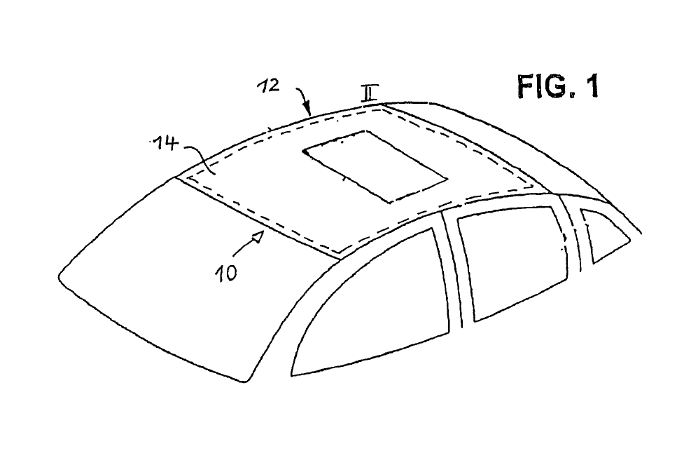

FIG. 1 illustrates a vehicle body panel part in the form of a roof module 10, which is a large-surface composite structure that is attached to the roof frame 12 by bonding. The roof module 10 defines the outer skin, in this case the roof skin of the vehicle. As already mentioned, the roof module 10 is a composite structure, with the outer skin being formed by a sheet 14. The sheet 14 itself can be configured as a deep-drawn aluminum sheet or a plastic sheet dyed throughout.

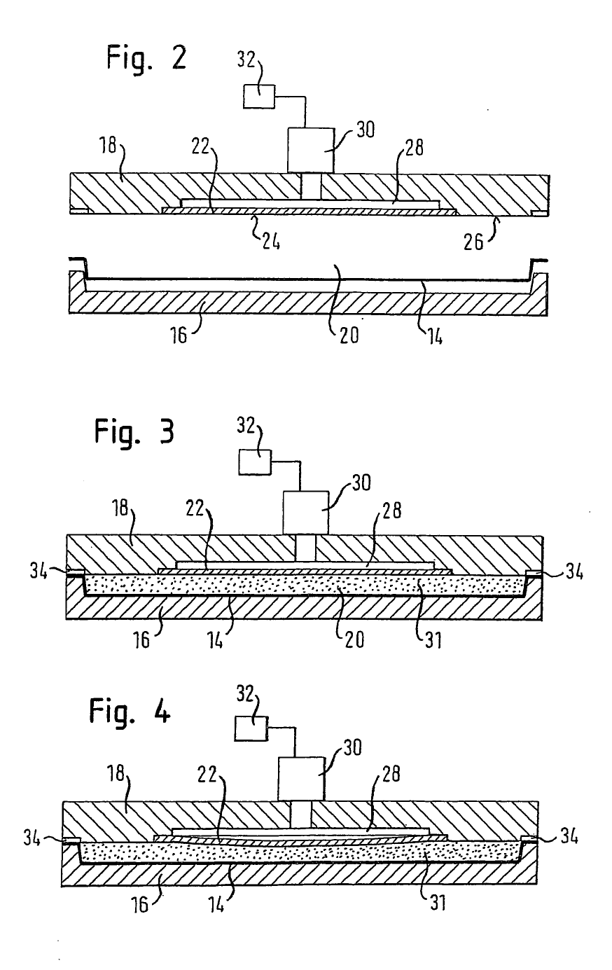

The roof module is manufactured in the foaming die, which is illustrated in FIGS. 2 to 4. The foaming die comprises a lower part 16 and an upper part 18, both of which can be moved together or apart. When the lower part 16 and the upper part 18 are moved together, they define the inside of a foaming cavity 20. In the illustrated embodiment, the lower part 16 comprises a trough-shaped depression while the upper part 18 is nearly flat.

A large-surface membrane 22 of a flexible material is secured in the upper part 18. The inside 24 of the membrane 22 is flush with the inside 26 of the upper part 18 at the edge of the membrane 22. At its edges, the membrane 22 is attached to the upper part 18. A pressure chamber 28 is disposed on the outside of the membrane 22 (i.e., on the side facing away from the foaming cavity 20). The pressure chamber 28 has a relatively small height and extends over almost the entire surface area of the membrane 22, with the exception of its attaching edges. This pressure chamber 28 is fluidically connected with a pump 30.

When the foaming die is closed, the pressure chamber 28 is separated from the foaming cavity 20 in a gas-tight manner by the membrane 22.

The vehicle body panel part in the form of the roof module 10 is manufactured as follows. The deep-drawn sheet 14 is first placed into the lower part 16 when the foaming die is open (FIG. 2). Afterwards, a liquid plastic material 31, such as liquid polyurethane, is applied on the rear side of the sheet 14.

The upper part 18 of the foaming die is moved onto the lower part 16 to close the foaming die (FIG. 3). The so-called degassing in the liquid plastic material 31 begins, which increases the volume of the plastic material 31. The plastic material 31 comes into contact with the membrane 22 and the gas bubbles in the plastic material 31 drift upward to the membrane 22 and push it upward so that the membrane bends towards the pressure chamber 28. Thus, the gas bubbles in the plastic material 31 are prevented from traveling excessively in the plastic material 31 toward the sheet 14, thereby preventing production of defective spots on the surface of the sheet 14.

The method can be terminated after the degassing and the bending of the membrane 22.

Optionally, the invention may also include a control device 32 that drives the pump 30 so that the pump increases the pressure in the pressure chamber 28 until the membrane 22 bends downward against the foaming pressure (FIG. 4). The gas is thereby transported to the sides and toward the outside of the foaming Because the pump 30 is driven periodically and causes the membrane 22 to swing periodically, it is possible to achieve a pumping effect or transporting function in the foaming cavity 20 for the released gas so that considerably more gas is transported to the outside by means of the gas outlet openings 34 than would be the case without the pump 30.

Regardless of whether or not the pump 30 is used, the surface quality of the component provided with a foam backing is improved due to the membrane 22.

It should be understood that various alternatives to the embodiments of the invention described herein may be employed in practicing the invention. It is intended that the following claims define the scope of the invention and that the method and apparatus within the scope of these claims and their equivalents be covered thereby.

1. A foaming die, comprising:
a lower part;
an upper part, wherein the lower part and the upper part form a foaming cavity therebetween;
a membrane that extends across an area and delimits the foaming cavity, wherein the membrane is mounted on an inside of at least one of the lower part and the upper part, and
a pressure chamber disposed adjacent to an outside of the membrane.

2. The foaming die according to claim 1, wherein the pressure chamber can receive selective application of pressure.

3. The foaming die according to claim 1, further comprising a pump that is coupled to the pressure chamber.

4. The foaming die according to claim 3, further comprising a control device coupled to the pump, wherein the control device increases pressure on an outside of the membrane during outgassing of plastic material in the foaming die.

5. The foaming die according to claim 1, further comprising at least one gas outlet opening disposed between the lower part and the upper part.

6. A method of forming a component with a foamed backing in a foaming die having a lower part, an upper part, and a membrane mounted on an inside of at least one of the lower part and the upper part to delimit a foaming cavity therebetween, comprising:
placing a sheet in the lower part;
applying a plastic material on the sheet;
closing the foaming die by moving the upper part onto the lower part to place the plastic material into contact with the membrane that extends across an area and that delimits the foaming cavity; and
foaming the plastic material, wherein gas bubbles in the plastic material push the membrane toward a pressure chamber.

7. The method according to claim 6, further comprising selectively applying pressure to the pressure chamber.

8. The method according to claim 7, wherein the step of selectively applying pressure is conducted by a pump.

9. The method according to claim 6, further comprising increasing pressure on an outside of the membrane during outgassing of the plastic material in the foaming die.

10. The method according to claim 6, further comprising:
applying pressure to the membrane a plurality of times during outgassing of the plastic material to generate a pumping effect; and
transporting gas generated during outgassing to at least one gas outlet opening disposed between the lower part and the upper part.
